(19) United States
(12) Patent Application Publication
(10) Pub. No.: US 2022/0062085 A1
(43) Pub. Date: Mar. 3, 2022

(54) Foot Stretching Device

(71) Applicant: Jomarg Innovation Limited, Glasgow (GB)

(72) Inventor: Gerrard Farrell, Glasgow (GB)

(73) Assignee: Jomarg Innovation Limited, Glasgow (GB)

(21) Appl. No.: 17/603,906

(22) PCT Filed: Apr. 14, 2020
(86) PCT No.: PCT/EP2020/060420

§ 371 Date: Oct. 14, 2021

(30) Foreign Application Priority Data
Apr. 15, 2019 (GB) 1905291.9

(51) Int. Cl. A61H 1/02; A61H 15/00

(52) U.S. Cl. CPC A61H 1/0266; A61H 15/00; A61H 2001/027; A61H 2201/1253; A61H 2201/1418; A61H 2201/1642; A61H 2015/0014

(57) ABSTRACT

A foot stretching device for stretching the structures of a foot comprises a base for receiving a rear portion of the foot to be stretched and a toe plate for receiving the toes of the foot to be stretched. The toe plate is disposed on and pivotable relative to the base. The device further comprises a member coupled to and/or configured to engage the toe plate, such that a tensile force applied to the member by a user pivots the toe plate relative to the base. and thus the user's toes relative to the rear portion of their foot. This action causes the toes to move into a more extended position thus producing a stretch in the tissues of the foot, in particular the musculature associated with the planar fascia.

### FIELD

This relates to a foot stretching device and in particular, but not exclusively, to a foot stretching device for use in stretching the structures of the foot to retain and/or improve foot mobility and/or flexibility.

### BACKGROUND

An appropriate level of mobility and flexibility of the structures of the foot is a key factor in healthy foot function. Lack of flexibility can lead to problems with the foot during gait and so predispose one towards injury.

Stretching the structures of the foot, such as the muscles associated with the plantar fascia, can be used to retain or restore mobility and/or flexibility.

However, stretching the foot to retain or restore mobility can pose problems, especially to individuals who lack general whole body flexibility and can't easily access their forefoot manually.

### SUMMARY

According to a first aspect, there is provided a foot stretching device for stretching the structures of a foot, the device comprising:
a base for receiving a rear portion of the foot to be stretched thereon,
a toe plate for receiving the toes of the foot to be stretched thereon, wherein the toe plate is disposed on and pivotable relative to the base; and
a member coupled to and/or configured to engage the toe plate such that a tensile force applied to the member pivots the toe plate relative to the base.

In use, the base may be locatable on a support surface such as the ground or floor, and a user, preferably in a seated position, places their foot on the device with the rear portion of their foot located on the base and with their toes located on the toe plate. However, it will be understood that the device may be utilised without locating the base on a support surface. The user applies a tensile/pulling force on the member to pivot the toe plate relative to the base, and thus the user's toes relative to the rear portion of their foot. This action causes the toes to move into a more extended position thus producing a stretch in the tissues of the foot, in particular the musculature associated with the planar fascia. Repeated exercise over time assists in progressive strengthening and improved user flexibility.

It will be understood that the term “rear portion” of the foot means all parts of the foot other than the toes, although in some embodiments the base is configured to receive the toes and ball of the foot.

Beneficially, the device facilitates the stretching of the foot, in particular the musculature associated with the planar fascia, to retain or restore mobility and/or flexibility, and is particularly beneficial for those for those of limited general flexibility.

As described above, the toe plate is disposed on and pivotable relative to the base.

The toe plate may be pivotable in a plane perpendicular to a plane of a foot receiving surface of the base, that is the tensile force applied to the member causes the toe plate to pitch relative to the base.

The base may comprise a unitary construction, that is the base may be formed as a single piece.

Alternatively, the base may comprise a plurality of base portions, in particular two base portions. Where the base comprises a plurality of base portions, the base portions may be coupled together. The base portions may be removably coupled together.

The device may comprise a coupling arrangement for removably coupling the base portions together. The coupling arrangement may comprise one or more fastener such as a nut and bolt, or other suitable coupling arrangement.

Beneficially, the coupling arrangement permits the base portions to be moved relative to each other and then fixed in position to change the length of the base. This permits the device to be adapted to different users.

The base may be rigid or substantially rigid. The base may be inflexible or substantially inflexible. In the context of the present disclosure, the terms rigid and inflexible will be understood to mean that the base is of sufficient stiffness that the base does not flex in normal use.

The provision of a rigid or substantially rigid base permits the foot to work against the base without causing the base to flex, thereby ensuring that the tensile force applied to the member is converted efficiently into pivoting of the toe plate rather than to flexing the base.

The base may be constructed from any suitable material. The base may be constructed from a plastic material. For example, the base may be constructed from Acrylonitrile butadiene styrene (ABS), High Density Polyethylene (HDPE), Polypropylene (PP) the like. The base may be constructed from wood. The base may be constructed from a ceramic material. The base may be constructed from a composite material. For example, the base may be constructed from a fibre reinforced composite material, such as carbon fibre reinforced composite. The base may be of any suitable size and/or shape. The dimensions of the base may be selected to facilitate location of a range of foot sizes. The base may be rectangular or generally rectangular in shape. The provision of a rectangular base facilitate uses of the device on either foot as required.

The base may be configured to resist movement of the base relative to the support surface. For example, the outer surface of the base may comprise a non-slip surface or may comprise or provide mounting for a high friction material. Alternatively, the outer surface of the base may comprise ridges, grooves or other surface texture to resist movement of the base relative to the support surface.

The toe plate may be constructed from any suitable material and may be constructed from the same or a different material to that of the base.

The toe plate may be constructed from a plastic material. For example, the toe plate may be constructed from Acrylonitrile butadiene styrene (ABS), High Density Polyethylene (HDPE), Polypropylene (PP) the like. The toe plate may be constructed from wood. The toe plate may be constructed from a ceramic material. The toe plate may be constructed from a composite material. For example, the toe plate may be constructed from a fibre reinforced composite material, such as carbon fibre reinforced composite.

As described above, the toe plate is pivotable relative to the base.

The toe plate and base may be integrally formed, the interface between the toe plate and the base defining a living hinge or the like.

Alternatively, the toe plate may be coupled to the base.

The toe plate may be directly coupled to the base. For example, the device may comprise one or more hinge for coupling the toe plate to the base. The hinge may be made of steel.

Alternatively, the toe plate may be indirectly coupled to the base. For example, the device may comprise a mounting bracket for mounting the toe plate to the base. The mounting bracket may be interposed between the toe plate and the base. The mounting bracket may comprise or take the form of one or more mounting plate.

The toe plate may be pivotably coupled to the mounting bracket. The device may comprise one or more hinge for pivotably coupling the toe plate to the mounting bracket.

Alternatively, the toe plate and mounting bracket may be integrally formed, the interface between the toe plate and the mounting bracket defining a living hinge or the like.

The mounting bracket may be coupled to the base.

The mounting bracket may be fixedly coupled to the base.

Alternatively, the mounting bracket may be removably coupled to the base. The device may comprise a coupling arrangement for removably coupling the mounting bracket to the base. The coupling arrangement may comprise one or more fastener such as a nut and bolt, a screw, a pin and socket arrangement, hoop and loop fastener or other suitable coupling arrangement.

Beneficially, the coupling arrangement allows the mounting bracket to be moved on the base and then fixed in position. The provision of a mounting bracket which is removably coupled to the base permits the position of the toe plate relative to the base to be adjusted, permitting the device to be adapted to different users.

The mounting bracket may comprise or take the form of a unitary construction, that is the mounting bracket may be formed as a single piece.

Alternatively, the mounting bracket may comprise a plurality of mounting bracket portions. For example, the mounting bracket may comprise a first mounting portion to which the toe plate is pivotably coupled and a second mounting portion for coupling the first mounting plate to the base.

The second mounting portion may comprise or take the form of a mounting plate.

The device may comprise a coupling arrangement for removably coupling the first mounting portion to the second mounting portion. The coupling arrangement may comprise one or more fastener such as a nut and bolt, a screw, a pin for location in a socket, hoop and loop fastener or other suitable coupling arrangement.

The device may comprise a coupling arrangement for removably coupling the second mounting portion to the base. The coupling arrangement may comprise one or more fastener such as a nut and bolt, a pin and socket, hoop and loop fastener or other suitable coupling arrangement.

The mounting bracket may comprise a third mounting portion. The third mounting portion may be interposed between the second mounting portion and the base.

The device may comprise a coupling arrangement for removably coupling the second mounting portion to the third mounting portion. The coupling arrangement may comprise one or more fastener such as a nut and bolt, a screw, a pin for location in a socket, hoop and loop fastener or other suitable coupling arrangement.

The device may comprise a coupling arrangement for removably coupling the third mounting portion to the base. The coupling arrangement may comprise one or more fastener such as a nut and bolt, a pin and socket, hoop and loop fastener or other suitable coupling arrangement.

The second mounting portion may comprise or take the form of a mounting plate.

The mounting bracket may be constructed from any suitable material, and may be constructed from the same or different materials to that of the base and/or toe plate.

The mounting bracket may be constructed from a plastic material. For example, the mounting bracket may be constructed from Acrylonitrile butadiene styrene (ABS), High Density Polyethylene (HDPE), Polypropylene (PP) the like. The mounting bracket may be constructed from wood. The mounting bracket may be constructed from a ceramic material. The mounting bracket may be constructed from a composite material. For example, the mounting bracket may be constructed from a fibre reinforced composite material, such as carbon fibre reinforced composite.

The device may be configured so that the toe plate is pivotable between a first position and a second position, the toe plate being moveable from the first position to the second position by the user applying the tensile force to the member.

The toe plate may be biased towards the first position, e.g. by one or more spring member coupled or otherwise disposed under the toe plate.

The device may be configured so that in the first position the toe plate is initially disposed at an inclined position with respect to the base.

The device may comprise a wedge portion configured to dispose the toe plate at the inclined position with respect to the base. The device may comprise a single wedge portion. Alternatively, the device may comprise a plurality of wedge portions.

The wedge portion may be integrally formed with, or may be coupled to, the toe plate.

Alternatively, the wedge portion may be integrally formed with, or may be coupled to, the mounting bracket.

The device may comprise a fixation arrangement for permitting the first position of the toe plate to be adjusted.

The fixation arrangement may comprise a linkage. The linkage may comprise or take the form of a cam and follower arrangement. The cam may comprise or take the form of an arcuate slot. The follower may comprise or take the form of a pin for engaging the cam, e.g. arcuate slot. The pin may comprise or may be operatively associated with a locking member, permitting the angle of incline of the toe plate to be selected. The locking member may, for example, comprise or take the form of a nut, e.g. wingnut, or other suitable lock.

As described above, the device comprises a member coupled to and/or configured to engage the toe plate such that a tensile force applied to the member pivots the toe plate relative to the base.

The member may comprise or take the form of an elongate member. For example, the member may comprise or take the form of a strap. Alternatively, the member may comprise or take the form of a tie, cable, rope, string, wire or the like.

The device may be configured with a first end of the member configured for coupling to or configured to engage the toe plate and a free end for grasping by the user.

Alternatively, the device may be configured with both ends of the member coupled to or configured to engage the toe plate, the member defining a loop for grasping by the user.

In use, the device may be configured so that the tensile force applied to the member results in a moment force about a pivot point between the toe plate and the base, the moment force pivoting the toe plate relative to the base.

The member may be coupled to or configured to engage a distal end portion of the toe plate. Beneficially, this maximizes the conversion of the tensile force applied by the user into the moment force which pivots the toe plate relative to the base. This is particularly beneficial for users with limited arm strength. However, it will be understood that the member may be coupled to or configured to engage any portion of the toe plate.

The member may be coupled to the toe plate by any appropriate means. For example, the member may be tied directly to the toe plate. The member may be coupled to the toe plate by means of an anchorage point on the toe plate. The anchorage point may, for example, comprise or take the form of a hook.

The member may be made of any suitable material. For example, the member may be constructed from leather or canvas. However, it will be understood that the member may alternatively or additionally be constructed from another fabric material, e.g. a webbing material or the like, rope, string, wire or other suitable material.

The device may comprise a heel stop.

Beneficially, the heel stop may prevent or reduce movement of the foot on the base.

The heel stop may be disposed on the base. The heel stop may be disposed on an upper surface of the base. The heel stop may be disposed on a rear portion of the upper surface of the base.

The heel stop may be coupled to the base. The heel stop may be fixedly coupled to the base. In particular embodiments, the heel stop may be removably coupled to the base.

The device may comprise a coupling arrangement for coupling the heel stop to the base. The coupling arrangement may comprise one or more fastener such as a bolt, screw, pin and socket arrangement, hook and loop arrangement or other suitable coupling arrangement.

Alternatively, the heel stop may be integrally formed with the base.

The heel stop may be arcuate in shape. Beneficially, the heel stop may be shaped to extend around a portion of the user's heel, assisting in restricting both axial and lateral movement of the foot.

The heel stop may comprise or take the form of a unitary construction, that is a single piece.

Alternatively, the heel stop may comprise a plurality of components.

The heel stop may comprise a roller. The roller may take the form of elongate roller, journal or the like. The roller may comprise an axle. The roller may be constructed from a rigid or inflexible material, such as steel or a rigid plastic.

The roller may comprise or provide mounting for a sleeve. The sleeve may be disposed on and around the axle.

The sleeve may be constructed from any suitable material, for example foam, cork or polystyrene.

In use, the roller and/or sleeve may be configured to apply a counter force to the heel in a comfortable fashion.

The heel stop may comprise a roller support arrangement for rotatably supporting the roller. The roller support arrangement may comprise roller support members extending from the upper surface of the base. The roller support members may be disposed at respective ends of the roller so as to rotatably support the roller. The roller support members may be shaped or otherwise configured to define seats for receiving the roller. A bearing may be provided or defined between the roller and the roller support arrangement, to facilitate rotation of the roller relative to the roller support arrangement. The bearing may take the form of a plain bearing. Alternatively, the bearing may take the form of a roller bearing, journal bearing or other suitable bearing.

The device may be configured so that the roller is removable from the roller support arrangement. Beneficially, this permits a range of rollers to be used and/or facilitates removal of the roller for replacement.

The roller support arrangement may comprise one or more locking members for retaining the roller in the roller support arrangement. The locking members may be configured for coupling to the roller support members. A coupling arrangement may be provided to secure the locking members to the roller support members. The coupling arrangement may comprise or take the form of one or more fastener such as a bolt, screw, pin or the like.

The locking members may be pivotably coupled, e.g. by hinges, to the roller support members.

Beneficially, the locking members can be removed or pivoted to facilitate access to the roller, to permit replacement and/or to permit the insertion of another roller.

The roller support arrangement may be integrally formed with the base. Alternatively, the roller support arrangement may comprise a separate component and may be coupled to the base. The roller support arrangement may be fixedly coupled to the base. In particular but not exclusively, the roller support arrangement may be removably coupled to the base. A coupling arrangement may be provided to removably couple the roller support arrangement to the base. The coupling arrangement may comprise one or more fastener, such as a nut and bolt, screw, pin and socket, hook and loop arrangement or other suitable coupling arrangement.

Beneficially, this permits the device to be adapted to a variety of users.

The device may comprise a resilient member for location over an upper portion of the foot. The device may comprise one resilient member or a plurality of resilient members. The resilient member may be adapted to exert a resistive force on the foot as the foot is moved.

The resilient member may be of any suitable form. For example, the resilient member may comprise an elastic band, cord or the like. Alternatively, or in addition, the resilient member may comprise a spring. The resilient member may be adapted to stretch and contract in response to movement of the foot between the extended and retracted positions, whereby repeated movement facilitates progressive strengthening of the foot, for example the muscles associated with the plantar fascia.

Where a plurality of resilient members are provided, each resilient member may be of the same or different resistance as required to provide a selected resistive force on the foot. The, or each, resilient member may be adapted to be removed and/or interchanged to permit the selected resistive force to be modified to strengthen the foot as required.

The resilient member may be coupled to the base.

The resilient member may be coupled directly to the base. For example, the base may comprise slots through which ends of the resilient member are disposed and/or secured.

Alternatively, the device may comprise rails on either side of the base to which ends of the resilient member are attached or secured.

The ends of the resilient member or members may be provided with or form cleats.

The foot stretching device may be formed as a kit of parts.

According to another aspect, there is provided a method for stretching a foot, the method comprising:
providing a foot stretching device according to the first aspect;
placing the foot on the device with the rear portion of the foot placed on the base and the toes placed on the toe plate; and
applying a tensile force to the member so as to force to the toes by applying force to a member coupled to the toe plate.

The device may comprise a heel stop and the method may comprise resting the heel of the foot against the heel stop to reduce movement of the foot on the base during the stretching process.

According to another aspect, there is provided a method of massaging a foot, the method comprising:
providing a foot stretching device according to the first aspect;
placing a foot on a roller coupled to the base and moving the foot across the roller; and
moving the foot backwards and forwards across the roller.

The roller may form part of a heel stop of the foot stretching device.

The heel stop may comprise a roller. The roller may take the form of elongate roller, journal or the like. The roller may comprise an axle. The roller may comprise a sleeve. The sleeve may be disposed on and around the axle.

The heel stop may comprise a roller support arrangement for rotatably supporting the roller. The roller support arrangement may comprise roller support members extending from the upper surface of the base. The roller support members may be disposed at respective ends of the roller so as to rotatably support the roller. The roller support members may be shaped or otherwise configured to define seats for receiving the roller. A bearing may be provided or defined between the roller and the roller support arrangement, to facilitate rotation of the roller relative to the roller support arrangement. The bearing may take the form of a plain bearing. Alternatively, the bearing may take the form of a roller bearing, journal bearing or other suitable bearing.

The device may be configured so that the roller is removable from the roller support arrangement. Beneficially, this permits a range of rollers to be used and/or facilitates removal of the roller for replacement.

The roller support arrangement may comprise one or more locking members for retaining the roller in the roller support arrangement. The locking members may be configured for coupling to the roller support members. A coupling arrangement may be provided to secure the locking members to the roller support members. The coupling arrangement may comprise or take the form of one or more fastener such as a bolt, screw, pin or the like.

The locking members may be pivotably coupled, e.g. by hinges, to the roller support members.

Beneficially, the locking members can be removed or pivoted to facilitate access to the roller, to permit replacement and/or to permit the insertion of another roller.

The roller support arrangement may be integrally formed with the base. Alternatively, the roller support arrangement may comprise a separate component and may be coupled to the base. The roller support arrangement may be fixedly coupled to the base. In particular but not exclusively, the roller support arrangement may be removably coupled to the base. A coupling arrangement may be provided to removably couple the roller support arrangement to the base. The coupling arrangement may comprise one or more fastener, such as a nut and bolt, screw, pin and socket, hook and loop arrangement or other suitable coupling arrangement.

Beneficially, this permits the device to be adapted to a variety of users.

Beneficially, the roller may be used both as a heel stop during stretching of the foot and as a foot massager when the foot is placed on top of the roller.

It should be understood that the features defined above in accordance with any aspect of the present invention may be utilized, either alone or in combination with any other defined feature, in any other aspect of the invention.

### BRIEF DESCRIPTION OF THE DRAWINGS

These and other aspects will now be described with reference to the accompanying drawings, of which:

FIG. 1 shows a perspective view of a foot stretching device;

FIG. 2 shows another perspective view of the foot stretching device shown in FIG. 1;

FIG. 3 shows a perspective view of an alternative foot stretching device;

FIG. 4 shows an enlarged cross-sectional view of part of the foot stretching device shown in FIG. 3;

FIG. 5 shows a bottom view of the base of the foot stretching device shown in FIG. 3;

FIG. 6 shows a perspective exploded view of a heel stop of the foot stretching device shown in FIG. 3

FIG. 7 shows an end view of the heel stop shown in FIG. 6;

FIGS. 8, 9 and 10 show the foot stretching device shown in FIG. 3, being used by a seated user;

FIG. 11 shows a perspective view of an alternative foot stretching device, in use;

FIG. 12 shows an enlarged perspective view of a mounting bracket and toe plate of the foot stretching device shown in FIG. 11;

FIG. 13 shows a perspective view of an alternative foot stretching device;

FIG. 14 shows an enlarged perspective view of a mounting bracket and toe plate of the foot stretching device shown in FIG. 13;

FIG. 15 shows an exploded view of an adjustment mechanism of the foot stretching device shown in FIG. 13;

FIG. 16 shows a perspective view of an alternative foot stretching device;

FIG. 17 shows an enlarged perspective view of part of the foot stretching device shown in FIG. 16;

FIG. 18 shows a side view of an alternative foot stretching device;

FIG. 19 shows a bottom view of the foot stretching device shown in FIG. 18;

FIG. 20 shows an alternative foot stretching device; and

FIG. 21 shows an alternative design of the heel stop.

### DETAILED DESCRIPTION OF THE DRAWINGS

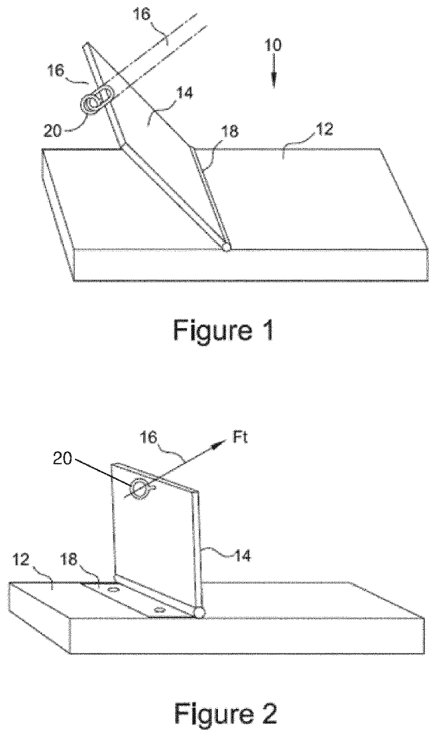

Referring initially to FIGS. 1 and 2 of the accompanying drawings, there is shown a foot stretching device 10.

As shown in FIGS. 1 and 2, the device 10 comprises a base 12 for receiving a rear portion of the foot to be stretched thereon, a toe plate 14 for receiving the toes of the foot to be stretched thereon. The toe plate 14 is disposed on and pivotable relative to the base 12. The device 10 further comprise a member 16 coupled to and/or configured to engage the toe plate 14 such that a tensile force Ft applied to the member 16 pivots the toe plate 14 relative to the base 12.

In use, the foot is located on the base 12 with the toes (or in some instances the toes and the ball of the foot) on the toe plate 14 whilst the heel rests on the base 12. Force is then exerted on the toe plate 14 by pulling (applying a tensile force) on the member 16 in for example the direction A shown in FIG. 2. The force produced on the toe plate 14 will be transmitted to the toes and will cause them to move into a more extended position thus producing a stretch in the tissues of the foot. This action causes the toes to move into a more extended position thus producing a stretch in the tissues of the foot, in particular the musculature associated with the planar fascia. Repeated exercise over time assists in progressive strengthening and improved user flexibility. Putting tension on the toe plate 14 by pulling on the member 16 will now not only extend the toes but reduce the distance between the ball of the foot and the heel thus stretching the structures of the midfoot in a more targeted fashion.

Beneficially, the device 10 facilitates the stretching of the foot, in particular the musculature associated with the planar fascia, to retain or restore mobility and/or flexibility, and is particularly beneficial for those for those of limited general flexibility.

In the illustrated device 10, the base 12 comprises a unitary construction, that is the base 12 is formed as a single piece. The base 12 is rigid or substantially rigid, that is the base 12 is of sufficient stiffness that the base 12 does not flex in normal use.

The provision of a rigid or substantially rigid base 12 permits the foot to work against the base 12 without causing the base 12 to flex, thereby ensuring that the tensile force applied to the member 16 is converted efficiently into pivoting of the toe plate 14 rather than to flexing the base 12.

In the illustrated device 10, the base 12 and the toe plate 14 are constructed from a plastic material. However, it will be understood that the base 12 may alternatively be constructed from other suitable materials.

As described above, the toe plate 14 is pivotable relative to the base 12 and in the illustrated device 10, the toe plate 14 is pivotably coupled directly to the base 12 via a hinge 18.

As described above, the member 16 is coupled to and/or configured to engage the toe plate 14 such that a tensile force applied to the member 16 pivots/pitches the toe plate 14 relative to the base 12.

In the illustrated device 10, the member 16 comprises or takes the form of an elongate strap.

A first end of the member 16 is configured for coupling to or configured to engage the toe plate 14 and has a free end for grasping by the user.

In use, the device 10 is configured so that the tensile force applied to the member 16 results in a moment force about the hinge 18 between the toe plate 14 and the base 12, the moment force pivoting the toe plate 14 relative to the base 12.

The member 16 is coupled to or configured to engage a distal end portion of the toe plate 14. Beneficially, this maximizes the conversion of the tensile force applied by the user into the moment force which pivots the toe plate 14 relative to the base 12. This is particularly beneficial for users with limited arm strength. However, it will be understood that the member 16 may be coupled to or configured to engage any suitable portion of the toe plate 14.

The member 16 may be coupled to the toe plate 14 by any appropriate means. In the illustrated device 10, the member 16 is coupled to the toe plate 14 by means of an anchorage point 20 on the toe plate 14. The anchorage point 20 in the illustrated device 10 comprises or takes the form of a hook.

In the illustrated device 10, the member 16 is constructed from leather. However, it will be understood that the member may alternatively or additionally be constructed from another fabric material, e.g. a webbing material or the like, rope, string, wire or other suitable material.

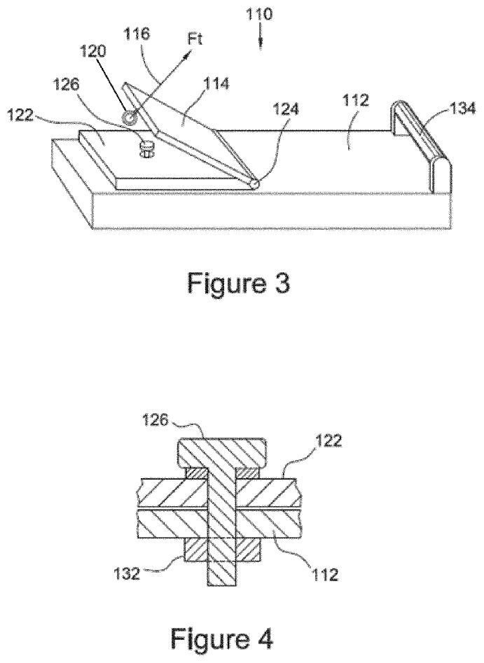

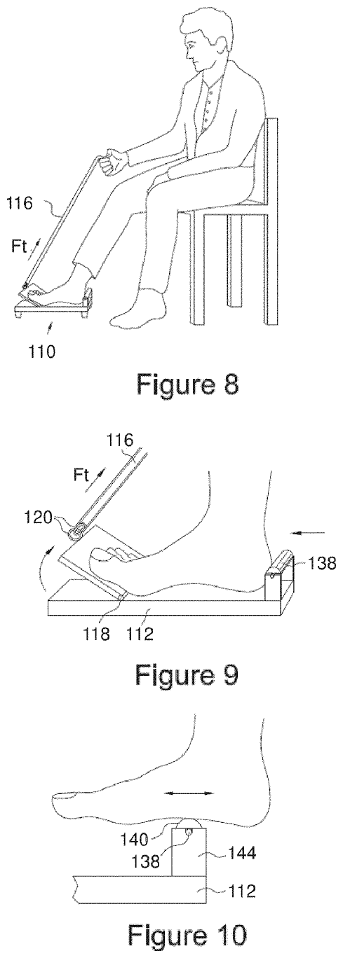

Referring now to FIGS. 3 to 10 of the accompanying drawings, there is shown an alternative foot stretching device 110.

As shown in FIG. 3, the device 110 comprises a base 112 for receiving a rear portion of the foot to be stretched thereon, a toe plate 114 for receiving the toes of the foot to be stretched thereon. The toe plate 114 is disposed on and pivotable relative to the base 112. The device 110 further comprise a member 116 coupled to and/or configured to engage the toe plate 114 such that a tensile force Ft applied to the member 116 pivots the toe plate 114 relative to the base 112.

The member 116 may be coupled to the toe plate 114 by any appropriate means. In the illustrated device 10, the member 116 is coupled to the toe plate 114 by means of an anchorage point 120 on the toe plate 114. The anchorage point 120 in the illustrated device 10 comprises or takes the form of a hook.

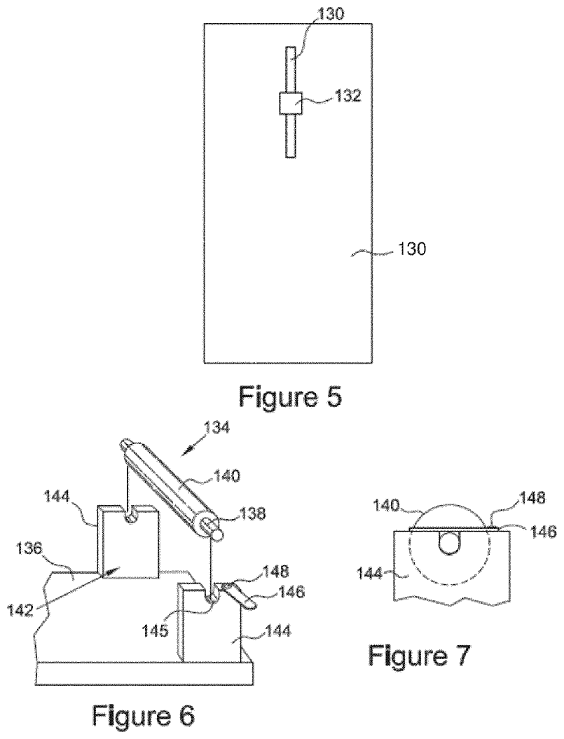

In the illustrated device 110, The toe plate 14 is hingedly attached to a mounting bracket in the form of second plate 122 by hinge 124. The second plate 122 can move on the base 112. Movement of the second plate 122 is guided by a bolt 126 (as shown in FIG. 4) which passes through the base 112 and in a slot 130 (as shown in FIG. 5).

Adjustments to the device 110 are made by loosening a nut 132 on the bolt 126 and then moving the second plate 122 until it is on the desired position on the base 12. The assemblage can then be fixed in position by tightening the nut 132.

In the illustrated device 110, and referring in particular to FIGS. 6 and 7 of the accompanying drawings, the device 110 further comprises a heel stop 134 is provided to reduce movement of the foot on the base 112.

As shown in FIGS. 6 and 7, the heel stop 134 is disposed on a rear portion of an upper surface 136 of the base 112 the base 112. The heel stop 134 comprises an elongate roller 138 and a sleeve 140 disposed on the roller 138.

The heel stop 134 further comprises a roller support arrangement, generally denoted 142, for rotatably supporting the roller 138. The roller support arrangement 142 comprises roller support members 144 extending from the upper surface 136 of the base 112. The roller support members 144 are disposed at respective ends of the roller 138 so as to rotatably support the roller 138 and are shaped or otherwise configured to define seats 145 for receiving the roller 138. A plain bearing is provided or defined between the roller 138 and the roller support members 144, to facilitate rotation of the roller 138 relative to the roller support arrangement 142.

As shown in FIG. 6, the device 110 is configured so that the roller 138 is removable from the roller support arrangement 142. Beneficially, this permits a range of rollers 138 to be used and/or facilitates removal of the roller 138 for replacement.

The ends of the roller 138 can be held in place by locking members 146 which pivot about hinges 148.

Beneficially, locking members can be removed or pivoted to facilitate access to the roller, to permit replacement and/or to permit the insertion of another roller.

Alternatively, roller 138 and sleeve 140 may be coupled together so that they rotate as a single unit.

As shown in FIG. 10, the heel stop 134 can be used as a foot roller to massage a surface of the foot. To achieve the massage effect, the foot is positioned on top of the roller 138 and the foot is moved backwards and forwards across the roller 138.

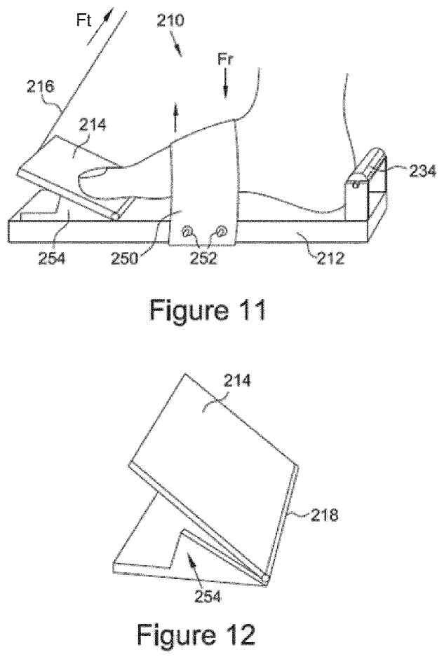

Referring now to FIGS. 11 and 12 of the accompanying drawings, there is shown an alternative foot stretching device 210. FIGS. 11 shows a perspective view of the foot stretching device 210, in use. FIG. 12 shows an enlarged perspective view of a mounting bracket and toe plate of the foot stretching device 210 shown in FIG. 11.

As shown in FIGS. 11 and 12, the device 210 comprises a base 212 for receiving a rear portion of the foot to be stretched thereon, a toe plate 214 for receiving the toes of the foot to be stretched thereon. The toe plate 214 is disposed on and pivotable relative to the base 212. The device 210 further comprise a member 216 coupled to and/or configured to engage the toe plate 214 such that a tensile force Ft applied to the member 216 pivots the toe plate 214 relative to the base 212.

As shown in FIG. 11, the device 210 comprises a foot stop 234, which in the illustrated device 210 takes the form of a rectangular plate extending upwards from the base 212.

In the illustrated device 210, the device 210 further comprises a resilient member 250 for location over an upper portion of the foot. The device 210 comprises one resilient member 250. However, it will be understood that the device 210 may alternatively comprise a plurality of resilient members 250. The resilient member 250 exerts a resistive force on the foot as the foot is moved.

In the illustrated device 210, the resilient member 250 comprises an elastic band, cord or the like. The resilient member 250 is adapted to stretch and contract in response to movement of the foot between extended and retracted positions, whereby repeated movement facilitates progressive strengthening of the foot, for example the muscles associated with the plantar fascia.

The resilient member 250 is coupled to the base 212 by fasteners 252, which in the illustrated device 210 take the form of rivets.

As shown most clearly in FIG. 12 toe plate 214 is hingedly coupled to a mounting bracket in the form of wedge 254 via hinge 218. The wedge 254 is constructed to hold the toe plate 214 at an inclined angle

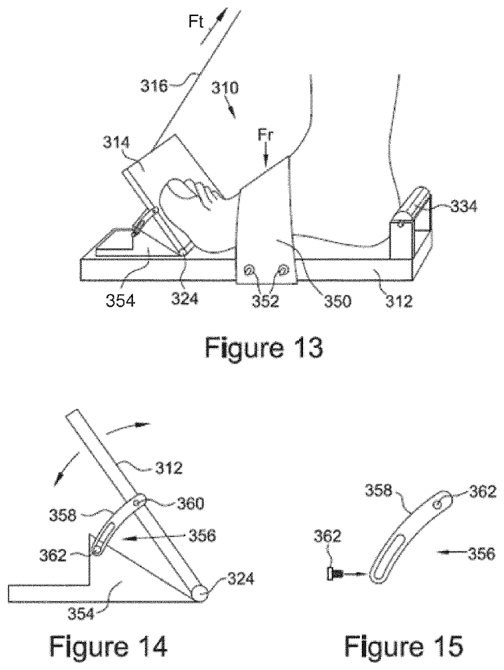

Referring now to FIGS. 13, 14 and 15 of the accompanying drawings, there is shown an alternative foot stretching device 310. FIG. 13 shows a perspective view of the foot stretching device 310. FIG. 14 shows an enlarged perspective view of a mounting bracket and toe plate of the foot stretching device shown in FIG. 13. FIG. 15 shows an exploded view of an adjustment mechanism of the foot stretching device shown in FIG. 13.

As shown in FIG. 13, the device 310 comprises a base 312 for receiving a rear portion of the foot to be stretched thereon, a toe plate 314 for receiving the toes of the foot to be stretched thereon. The toe plate 314 is disposed on and pivotable relative to the base 312. The device 310 further comprise a member 316 coupled to and/or configured to engage the toe plate 314 such that a tensile force Ft applied to the member 316 pivots the toe plate 314 relative to the base 312.

The device 310 comprises a foot stop 334, which in the illustrated device 310 takes the form of a rectangular plate extending upwards from the base 312.

The device 310 further comprises a resilient member 350 for location over an upper portion of the foot. The device 310 comprises one resilient member 350. However, it will be understood that the device 310 may alternatively comprise a plurality of resilient members 350. The resilient member 350 exerts a resistive force on the foot as the foot is moved. The resilient member 350 is coupled to the base 312 by fasteners 352, which in the illustrated device 210 take the form of rivets.

In the illustrated device 310, the resilient member 350 comprises an elastic band, cord or the like. The resilient member 350 is adapted to stretch and contract in response to movement of the foot between extended and retracted positions, whereby repeated movement facilitates progressive strengthening of the foot, for example the muscles associated with the plantar fascia.

In the device 310, the toe plate 314 is hingedly coupled to a mounting bracket in the form of wedge 354 via hinge 324. The wedge 354 is constructed to hold the toe plate 314 at an inclined angle (first position)

As shown in FIGS. 14 and 15, in addition, the toe plate 314 may be located at a range of angles (range of different first positions) relative to the base 312 by an adjustment mechanism, generally denoted 356. The adjustment mechanism 356 comprises a linkage 358 fixed to the toe plate 314 but can move around the fixation bolt 360. A second fixation bolt 362 can tighten and fix the linkage 358.

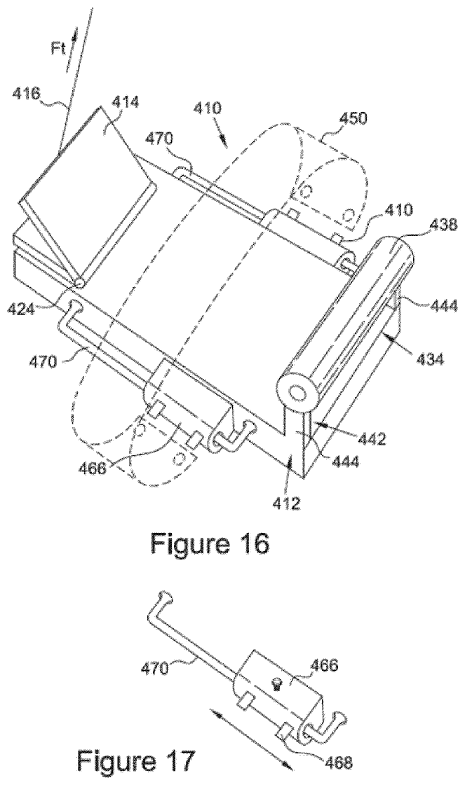

Referring now to FIGS. 16 and 17 of the accompanying drawings, there is shown an alternative foot stretching device 410. FIG. 16 shows a perspective view of the foot stretching device 410. FIG. 17 shows an enlarged perspective view of part of the foot stretching device shown in FIG. 16.

As shown in FIG. 16, the device 410 comprises a base 412 for receiving a rear portion of the foot to be stretched thereon, a toe plate 414 for receiving the toes of the foot to be stretched thereon. The toe plate 414 is disposed on and pivotable relative to the base 412. The device 410 further comprise a member 416 coupled to and/or configured to engage the toe plate 414 such that a tensile force Ft applied to the member 416 pivots the toe plate 414 relative to the base 412.

As shown, toe plate 414 is hingedly coupled to a mounting bracket in the form of second plate 422 by hinge 42.

The device 410 further comprises a heel stop 434 provided to reduce movement of the foot on the base 412. The heel stop 434 is disposed on a rear portion of an upper surface 436 of the base 412 the base 412. In the illustrated device 410, the heel stop 434 comprises a fixed bar 438 mounted on a support arrangement, generally denoted 442, comprising support arms 444.

The device 410 further comprises a resilient member 450 for location over an upper portion of the foot. The device 410 comprises one resilient member 450. However, it will be understood that the device 410 may alternatively comprise a plurality of resilient members 450. The resilient member 450 exerts a resistive force on the foot as the foot is moved.

The ends of the resilient member 450 are coupled to sliders 466 by cleats 468 coupled to sliders 468 slidably mounted on rails 470 on the sides of the base 412.

In the illustrated device 410, the resilient member 450 comprises an elastic band, cord or the like. The resilient member 450 is adapted to stretch and contract in response to movement of the foot between extended and retracted positions, whereby repeated movement facilitates progressive strengthening of the foot, for example the muscles associated with the plantar fascia.

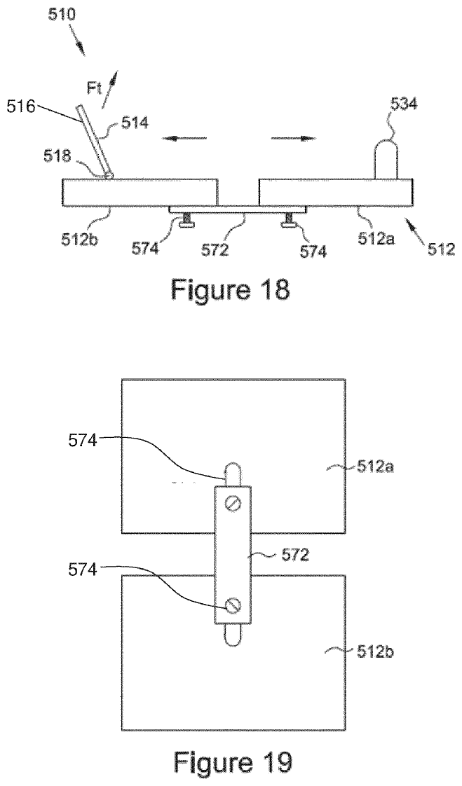

Referring now to FIGS. 18 and 19 of the accompanying drawings, there is shown an alternative foot stretching device 510. FIG. 18 shows a side view of the device 510. FIG. 19 shows a bottom view of the device 510 shown in FIG. 18.

As shown in FIG. 18, the device 510 comprises a base 512 for receiving a rear portion of the foot to be stretched thereon, a toe plate 514 for receiving the toes of the foot to be stretched thereon. The toe plate 514 is disposed on and pivotable relative to the base 512. The device 510 further comprise a member 516 coupled to and/or configured to engage the toe plate 514 such that a tensile force Ft applied to the member 516 pivots the toe plate 514 relative to the base 512.

As shown, toe plate 514 is directly coupled to the base 512 by hinge 518.

The device 510 further comprises a heel stop 534 provided to reduce movement of the foot on the base 512. In the illustrated device 510, the heel stop 534 takes the form of a rectangular plate extending upwards from the base 512.

As shown in FIGS. 18 and 19, in the device 510 the base 512 comprises two sections 512a,512b coupled together by a plate 572 which allows the sections to be moved relative to each other and then fixed in place by a securing means such as a nut and bolt arrangement 574.

It will be understood that various modifications can be made without departing from the scope of the invention as defined in the claims.

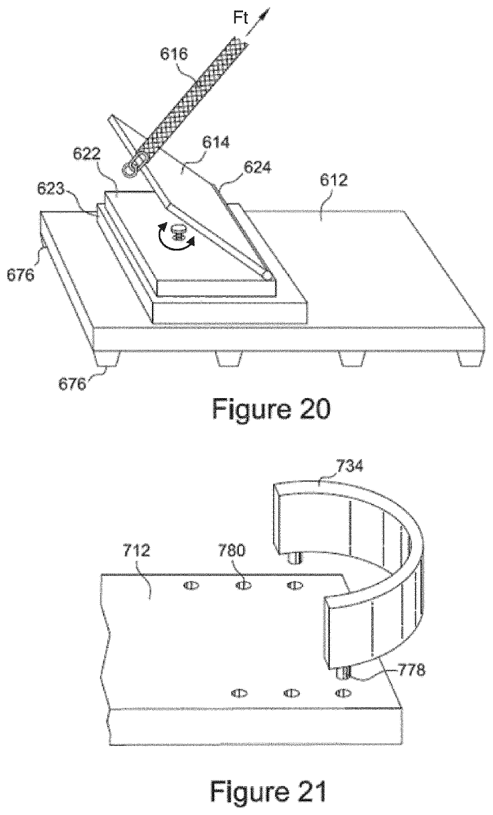

For example, FIG. 20 shows an alternative foot stretching device 610.

As shown in FIG. 20, the device 610 comprises a base 612 for receiving a rear portion of the foot to be stretched thereon, a toe plate 614 for receiving the toes of the foot to be stretched thereon. The toe plate 614 is disposed on and pivotable relative to the base 612. The device 610 further comprise a member 616 coupled to and/or configured to engage the toe plate 614 such that a tensile force Ft applied to the member 616 pivots the toe plate 614 relative to the base 612.

In the device 610, the toe plate 614 is pivotably coupled to the base 612 via a mounting bracket which comprises a second plate 622 and a third plate 623. The toe plate 614 is pivotably coupled to the second plate by hinge 624.

The base 612 is configured to resist movement of the base 612 relative to a support surface, the base 612 comprising feet 676.

FIG. 21 shows an alternative design of the heel stop, generally denoted 734. As shown in FIG. 21, the heel stop 734 is a padded arcuate block with pins 778 on its bottom surface which can be used to securely position the heel stop 734 by engaging with holes 780 located in base 712.

1. A foot stretching device for stretching the structures of a foot, the device comprising:
a base for receiving a rear portion of the foot to be stretched thereon;
a toe plate for receiving the toes of the foot to be stretched thereon, wherein the toe plate is disposed on and pivotable relative to the base; and
a member coupled to and/or configured to engage the toe plate such that a tensile force applied to the member pivots the toe plate relative to the base.

2. The device of claim 1, wherein the base comprises a plurality of base portions, and wherein the base portions are removably coupled together.

3. The device of claim 1, wherein the base is rigid or substantially rigid.

4. The device of claim 1, wherein the toe plate and the base are integrally formed, the interface between the toe plate and the base defining a living hinge.

5. The device of claim 1, wherein the toe plate is coupled to the base.

6. The device of claim 5, wherein the toe plate is indirectly coupled to the base.

7. The device of claim 6, comprising a mounting bracket for mounting the toe plate to the base.

8. The device of claim 7, wherein the mounting bracket comprises or takes the form of one or more mounting portion.

9. The device of claim 7, wherein the toe plate is pivotably coupled to the mounting bracket.

10. The device of claim 8, wherein the toe plate and the mounting bracket are integrally formed, the interface between the toe plate and the mounting bracket defining a living hinge.

11. The device of claim 7, wherein the mounting bracket is removably coupled to the base.

12. The device of claim 1, wherein the device is configured so that the toe plate is pivotable between a first position and a second position, the toe plate being moveable from the first position to the second position by the user applying the tensile force to the member.

13. The device of claim 12, wherein at least one of:
the toe plate is biased towards the first position;
the device is configured so that in the first position the toe plate is initially disposed at an inclined position with respect to the base; and
comprising one or more wedge portion configured to dispose the toe plate at the inclined position with respect to the base.

14. (canceled)

15. (canceled)

16. The device of claim 1, comprising a linkage for controlling the range of movement of the toe plate.

17. (canceled)

18. The device of claim 1, wherein the member comprises or takes the form of: a strap; a tie, a cable; a rope; a string; or a wire.

19. The device of claim 1, comprising a heel stop.

20. The device of claim 19, wherein at least one of:
the heel stop is removably coupled to the base;
the heel stop is arcuate in shape; and
the heel stop comprises a roller.

21. (canceled)

22. (canceled)

23. The device of claim 1, comprising or more resilient member configured for location over an upper portion of the foot.

24. A method for stretching a foot, the method comprising:
providing a foot stretching device according to claim 1;
placing the foot on the device with the rear portion of the foot placed on the base and the toes placed on the toe plate; and
applying a tensile force to the member so as to force to the toes by applying force to a member coupled to the toe plate.

25. A method of massaging a foot, the method comprising:
providing a foot stretching device according to claim 1;
placing a foot on a roller coupled to the base and moving the foot across the roller; and
moving the foot backwards and forwards across the roller.
